(19) United States
(12) Patent Application Publication
(10) Pub. No.: US 2007/0021166 A1
(43) Pub. Date: Jan. 25, 2007

(54) Method and device for user-controllable location mapping in location based gaming

(75) Inventor: Jouka Mattila, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/187,689

(22) Filed: Jul. 21, 2005

(51) Int. Cl. G06F 17/00

(52) U.S. Cl. 463/1

(57) ABSTRACT

A method is described for mapping in-game locations of a location based game to real-world locations, comprising determining that a player of the location based game has reached a game stage which requires mapping an in-game location to a real-world location, obtaining an indication of a real-world location, verifying the obtained real-world location, creating an association between the in-game location and the verified real-world location, and storing the association. A corresponding device and computer program product are also described.

### TECHNICAL FIELD

The invention is related to location based gaming, that is, games in which the location of the player is considered for the game play. In detail, the present invention relates to a method, computer program product, device and system for mapping of in-game locations to a real outer world location.

### PRIOR ART

Location based games are games in which the actual physical location of a participating player is used to trigger certain actions, for example awarding a player for having found a special place. Contrary to that a game may detect that a player is moving in the wrong direction, that is, he is moving away from a location he is supposed to find/visit, in order to issue additional information helping the player to get back on track. Other applications related to location based or location based gaming might be to inform players when they get within proximity of each other, create new missions for players when they come near some specific location chosen to trigger an event or like.

Location based gaming offers a complete new experience combining certain aspects of “at home” computer games with real actions/locations. This may give a whole new meaning to the term “mobile gaming”. Conventionally this term is understood as being able to play every time at every place, be it in a suburban train, subway train, bus, in the park or elsewhere. However the location where the game is played has no meaning for the game play itself, and neither is actual mobility, that is, moving around, in any way related to the game play. In location based gaming these two parameters, location of player and movement direction/speed, can be used to trigger certain events and to alter the plot of a game, objects to be fulfilled by the player(s) and the like.

In state of the art location based gaming the gamers might for example be sent out for finding something in a specific area and once it is detected that the gamer has entered the specified area or arrived at a specific location the game might send further instructions or award the gamer for having located/reached the specified place.

A possibility of location based games, particularly when keeping in mind the increasing so-called “massive multiplayer online gaming”, is that a high number of different participants or players can play together. A special attraction of such games is that even players from a totally different location, ranging from neighbor town over different state to different country at the opposite side of the globe, can participate in the games.

A problem which location based games that follows from this possibility is that it might not be possible for all players—especially when thinking about “massive multiplayer online gaming”—to reach the locations defined by the game with an acceptable effort or within an acceptable period of time, as the game might require the gamer to travel (that is, within the game world) to another town or even another country for reaching the specified location.

The very core of a location based game is to “connect” the game world with the real world. One important aspect of this is building up an association between in-game locations and real-world locations.

At present there are but very few existing location based games and creation methods. The most common method is to map the game directly to one location. This approach is called a 1:1 mapping method. This method only enables location based games that can be played in the certain place where they are mapped. For example a city or a specific city part can be assigned as the actual gaming area. As the respective region is known beforehand the mapping can easily be performed, and the actual geography of the area can be considered when building the associations.

This method however violates an unwritten rule for mobile gaming, saying that the game should be playable everywhere at any time. This is an important demand for the mass markets as they exist now.

The other method that is proposed for location based game concepts is that the game is mapped to the real world location through scaling. This may appear to be a good idea at a first glance; however the way it is actually done creates problems. If the game is set like a croquet game (lets call this scale method A), the player maps all the game areas to the real world places before starting the game-play. The problem here is that this set-up spoils the enjoyment of the player. The discovery of the game locations will be spoiled, because the player knows the number of the game locations before actually finding them. The other scaling method is that the player sets up the game world by using some parameters (let's call this scale method B), e.g. reducing all distances by a factor of 10 or 100. The parameter approach appears useful, but the risk is that some game areas will end up being located in real world places that might be unreachable, forbidden or even hazardous to the player.

Apart from the issues discussed above these set-up methods are rather complicated and take up a considerable amount of time and effort, which might prevent some players from entering a game, as he will easily get annoyed before even starting the game.

Therefore it is apparent that a method is desirable for mapping the game environment to the real-world, that is, in-game locations to real-world locations, which does not comprise the above discussed drawbacks. The inventive method enables location based games to be played even under conditions that may prevent conventionally mapped location based games from being played.

### SUMMARY OF THE INVENTION

According to an aspect a method is provided for mapping in-game locations of a location based game to real-world locations. The method comprises the steps of determining that a player of the location based game has reached a game stage which requires mapping an in-game location to a real-world location, obtaining an indication of a real-world location, verifying the obtained real-world location, creating an association between the in-game location and the verified real-world location, and storing the association.

Offering the player to choose the real-world location himself overcomes the drawbacks of the prior art mapping methods. The player will always be sure that only reasonable real-world locations are chosen, however the gaming experience is not disturbed by spoiling the actual locations too early. The inventive method is both flexible and convenient for the player.

According to an exemplary embodiment the obtaining step is preceded by requesting an indication of a real-world location. Usually the user will have to be prompted to enter an indication. However this request may also be directed to any other suitable entity, e.g., a game server.

According to an exemplary embodiment method further comprises returning to the requesting step in case the obtained real-world location is not verified. Off course the player has to be prevented from entering unreasonable real-world locations.

According to an exemplary embodiment a reference real-world location and a minimal and/or maximal distance are defined, and the verifying step comprises determining the distance of the obtained real-world location to the reference real-world location. The obtained real-world location is verified only if the distance is above the minimal and/or below the maximal distance. This enables the game programmer to pre-set minimal/maximal values for the mentioned distances, in order to ensure a proper gaming experience. This aspect will be explained in more detail in the subsequent description.

According to an exemplary embodiment the verifying step comprises retrieving information about the obtained real-world location, and using the retrieved information to determine if the obtained real-world location is located in an area that is forbidden, unreachable or hazardous to the player. The obtained real-world location is verified only if the obtained real-world location is not located in a forbidden, unreachable or hazardous area. This is provided to enable a kind of “sanity check” on the obtained location. As will be explained in detail later on the player should naturally be prevented from selecting real-world locations which are unreachable to him or can even put him in danger.

According to an exemplary embodiment the requesting step comprises requesting a confirmation that the present location of the player will be used as obtained real-world location, and the obtaining step comprises determining the present location of the player responsive to a confirmation, and using the present location as the obtained real-world location. This enables a very straight forward and fool-proof way of indicating the real-world location.

According to an exemplary embodiment the requesting step comprises choosing at least one real-world location and suggesting the chosen real-world location to the player, requesting a confirmation that the chosen real-world location will be used as the obtained real-world location, and the obtaining step comprises using the chosen real-world location as the obtained real-world location. This enables to present a suggestion to the player, which can be a convenient way to support him in his decision or even guide him towards certain decisions.

According to an exemplary embodiment the at least one real-world location is chosen according to the in-game location. The term “according to” is to be understood such that the proposed real-world location is chosen within the context of the corresponding in-game location. For example for an in-game “pub location” a number of real pubs, taverns or like can be proposed.

According to another aspect of the present invention a computer program product is provided, comprising program code means stored on a computer readable medium for carrying out the method of the invention when the program product is run on a computer or network device.

According to yet another aspect of the present invention a computer program product is provided, comprising program code, downloadable from a server for carrying out the method of anyone of the invention when the program product is run on a computer or network device.

According to still another aspect of the present invention a computer data signal embodied in a carrier wave and representing a program that instructs a computer to perform the steps of the method of the invention.

According to another aspect of the present invention a device for mapping in-game locations of a location based game to real-world locations is provided. The device comprises a display component, an input component, a storage component, a controller connected with the display component, the input component and the storage component. The controller is adapted for determining that a player of the location based game has reached a game stage which requires mapping an in-game location to a real-world location, requesting an indication of a real-world location using the display component, obtaining an indication of a real-world location using the input component, verifying the obtained real-world location, creating an association between the in-game location and the verified real-world location, and storing the association in the storage component.

According to an exemplary embodiment a reference real-world location and a minimal and/or maximal distance are stored in the storage component, and the controller is further adapted for determining the distance of the obtained real-world location to the reference real-world location. The controller is adapted to verify the obtained real-world location only if the distance is above the minimal and/or below the maximal distance.

According to an exemplary embodiment the controller is further adapted for retrieving information about the obtained real-world location, and using the retrieved information to determine if the obtained real-world location is located in an area that is forbidden, unreachable or hazardous to the player. The controller verifies the obtained real-world location only if the obtained real-world location is not located in a forbidden, unreachable or hazardous area.

According to an exemplary embodiment the device further comprises a location determination component. The controller is further adapted for requesting a confirmation that the present location of the player will be used as the real-world location using the display component, and determining the present location of the player using the location determination component, responsive to a confirmation through the input component, and using the present location as the obtained real-world location.

According to an exemplary embodiment a number of real-world locations are stored in the storage component, and the controller is further adapted for choosing at least one of the stored real-world locations and suggesting the chosen real-world location to the player using the display component, requesting a confirmation that the chosen real-world location will be used as the obtained real-world location using the display component, and using the chosen real-world location as the obtained real-world location responsive to a confirmation through the input component.

According to an exemplary embodiment the controller is further adapted for choosing the at least one real-world location according to the in-game location.

According to an exemplary embodiment the device is a mobile gaming terminal.

### BRIEF DESCRIPTION OF THE DRAWINGS

The invention can be more completely understood by referring to the following figures, which are provided only as illustrative but non-limiting examples of preferred embodiments, and in which

FIG. 1 depicts the basic procedure of an embodiment of the present invention in a flow chart;

FIG. 2 shows an example for a mapping table according to an embodiment of the present invention; and

FIG. 3 is a schematic view of a device according to an embodiment of the present invention.

### DETAILED DESCRIPTION OF THE INVENTION

A location based game consists of the game engine, location technology—for example the context engine— and the game itself which includes the graphics, storyline etc. When the player starts the game the player is mapped first into the storyline. As always in the beginning of the game the player location in the story line is the story's starting point. Next thing that the game does could be that it asks a player to accept the current location where the player currently is to be the first location of the location based game:

A) If the player feels that the location where he currently is might be a good place he can accept the game's suggestion.

B) If the player does not want to accept the location the player must find and select a new starting place where he wants to start the game.

The importance of the first place is of course depending on the game concept. When a player finds a good space then the player can continue playing. When the player advances in the storyline to the next place where the location based game wants to be mapped into the real world the game system can ask a similar question like “Do you want that your current location will be mapped as a location based game plot point?”. The procedure is similar as in cases A and B. This way the game runs until reaching the point where the game plot is solved and the game ends. The idea of location based gaming is that the player can return to the real world locations and they have meaning for the game play. Locations can be home bases, caverns or other locations in the game world. By going to the real world places the player is granted to enter the game world locations.

The game should include the plotline as a list that keeps track about the player's advance through the plot and the real world locations that the player has granted to be the access point to the game world locations. The distances of the real world locations can also be tracked by the game system, but that is dependant of the plot of the game and the game design itself. Any suitable location method could be used (WLAN, Cell-ID, GPS, BT) and it is also suggested that the Context Engine is used to get the context information.

The invention is based on providing the gamer the possibility to define the physical locations which are mapped to the locations in the game, in the following referred to as “in-game locations”. E.g. when starting the game the player can define the actual position as his “home position” in the game. A rather obvious choice for this would be the player's home. This home location is not only similarly important as any other location. It can furthermore be used for performing a kind of “sanity check” on the locations that are mapped later on. As will be explained in more detail in the following description an apparent parameter for verifying that only “sane” locations are entered is the distance to the starting point, the home location.

When the game advances the gamer will be given access to more locations, e.g. the player did solve some puzzle to find out which place he has to visit next in the game, or the presently reached game stage requires entering a new location/traveling to a new place to continue. Other possibilities could be that some other event triggers the necessity to add new locations, like when the gamer approaches a location/moves away from a location beyond a pre-set distance, a time-triggered event, a message from another player or the like. Generally speaking the player is given the possibility to reach a new in-game location or he is even required to enter this new location for the game to continue. To continue playing it is therefore necessary to assign a real-world location to this in-game location.

For example if the gamer needs to be at a specific location, lets say a pub, he might just define his favorite tavern just around the corner to be the “pub location”. Each time the gamer enters the tavern with his mobile game terminal the game detects that the gamer has entered the pub location, and can trigger certain events/actions, provide the gamer with new information enabling him to continue with the game, or just award him for having reached the location.

It is further assumed that the different gaming locations may be required to have a minimum (or maximum as well) distance even in the real world, so that it takes a certain effort for the gamer to first reach and later on re-enter a game location, which might be some hundred meters/a few kilometers from the “home location”. However this self-defined location will still be located in a distance which can be reached within an acceptable amount of time if the game requires him to enter the specified gaming location.

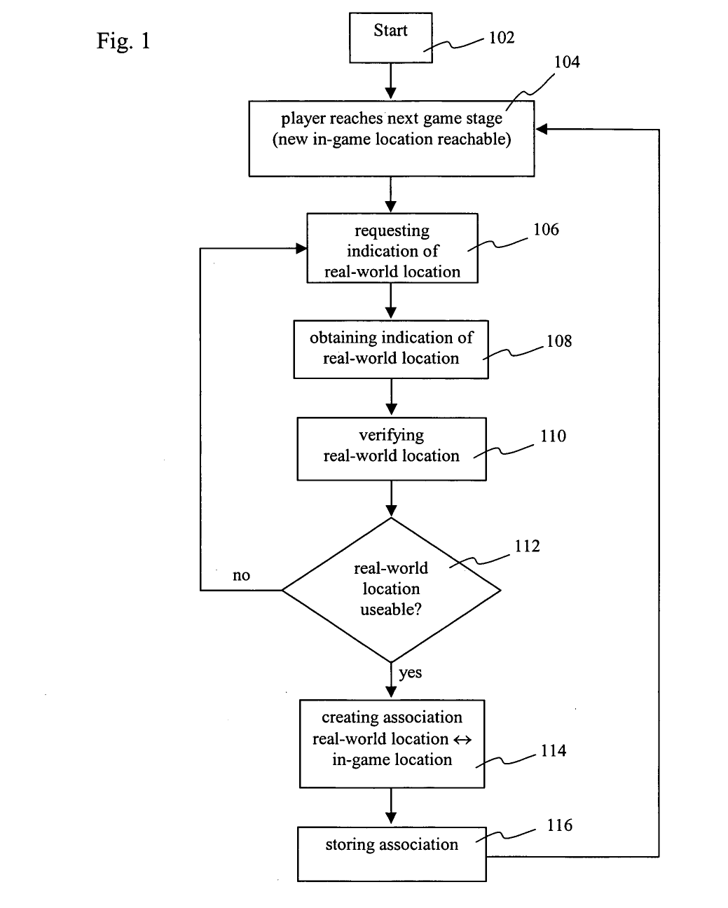

FIG. 1 describes a basic procedure for performing the inventive method. The process starts in step 102, that is, the player starts a game (or resumes a game after an interruption). In step 104 the game detects that the player has reached a game stage requiring that a new in-game location is mapped to a real-world location. For example the player solved a puzzle in order to be granted access to another location. There are also a plurality of different other conceivable possibilities that may require mapping new real-world locations. Therefore in step 106 a request is issued requesting that such a real-world location to be mapped to the new in-game location is indicated. In one embodiment of the invention the player himself is requested to indicate a location, however it is within the inventive concept that the location is also requested from another entity, e.g. the main game server or even other players.

One of these entities, that is, e.g. the player, then issues an indication of a real-world location he wants to be mapped to his newly reached in-game location. This indication is obtained in step 108. Obtaining in this context can mean that the player enters an indication into his mobile gaming terminal. Another possibility might be that the game server proposes a number of suitable real-world locations. There are also multiple other ways of indicating a location, e.g. directly by GPS coordinates or by selecting a location via touch screen that is being displayed as a map on the mobile gaming terminal. The artisan will be aware of a number of suitable ways of performing such a selection.

In step 110 the indicated real-world location is subjected to verification. It is apparent that the location should fulfill certain parameters. At the least it must be reachable for the player and must not be located in some hazardous area. Imagine the player accidentally indicating a position located in the middle of a freeway or like, and then desperately trying to reach it just to continue with playing. Therefore it is necessary to perform a “sanity check” on the indicated location. Another requirement, depending on the game, can be that the location is located within certain distances from reference points. On the one hand the player should be able to reach the location within a reasonable time and with reasonable effort, while on the other hand it might be rather boring if the location is located so nearby that it can be reached within moments. In multiplayer games it would also not be fair to favor a player with respect to others by letting him choose locations that are not located as far apart as that other players did select.

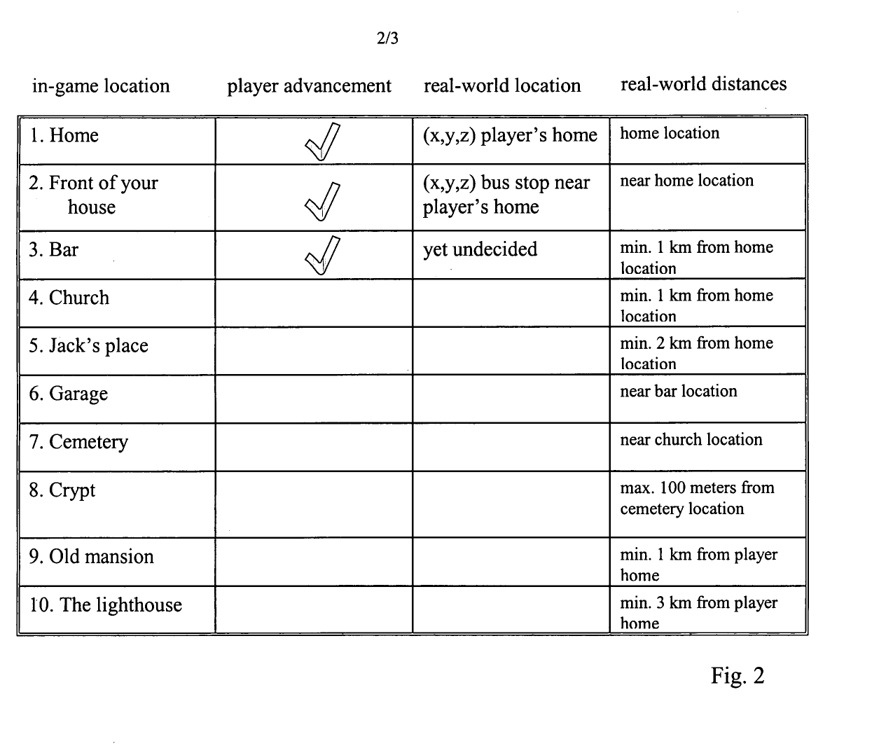

Therefore the verification step may also include checking the relative position of the indicated location with respect to other locations, e.g. the home location (which constitutes a starting point). This aspect will be discussed further in the subsequent detailed description of FIG. 2.

The limitations for the sanity check and requirements the indicated real-world locations have to meet can be set by the game programmer. These will usually be tied to the context of the game.

If the indicated real-world location is not found to be “sane” or useable in step 112 another request is issued to indicate a suitable location, that is, the procedure returns to step 106. Otherwise the indicated location is accepted and an association is created in step 114. That is, the indicated real-world location is mapped to the new in-game location. From now on the in-game location, say a pub, is mapped to the user-indicated real-world location, say his favorite tavern. In step 116 this association is stored. It is noted that it is also possible to re-map locations later on, if necessary.

Depending on the way the actual location is detected (which detection is not part of this invention) this storing can be performed by the mobile gaming device or the game server alone, or a combination of both. If the location detection is solely done within the mobile device then it is possible that the game server refers to the mapped location only by the in-game reference, without even knowing the actual position, as the mobile game device performs the corresponding detection and if necessary informs the game server that the location has been entered by the player. As location based gaming may pose a severe threat to the player's privacy this can help to enhance acceptance by protecting the privacy.

FIG. 2 illustrates an example of a mapping table. The first column contains the in-game locations, in this case in the order the game plot will make them available. The second column indicates if the player has advanced as far as to be granted access to certain locations. In the example depicted here the player has already advanced from his starting point via the front of his house to a bar (all locations being in-game locations), indicated in this table by the checkmarks. The third column shows the real-world locations the corresponding in-game locations are mapped to. In the example shown here the player has already chosen his starting point or home location as his home, and the location called “front of your house” to be the bus stop near his home. The locations can e.g. be identified through coordinates (indicated by (x, y, z)).

As can be seen here the player has apparently just advanced to the game stage where he is granted access to the location called “the bar”, and has not yet decided which real-world location shall be mapped thereto.

In the last column the required real-world distances are indicated. Shown here are certain distance-related conditions the selected real-world locations have to meet. To ensure a proper gameplay and conserve the atmosphere of a game it will usually be necessary to have certain relations between the real-world locations that reflect the corresponding relations of the in-game locations. For example it is quite apparent that the location called “front of your house” is not located three blocks from the starting point called “home”. Likewise a location that is sort of remote in the game context (here “the lighthouse”) should be located in a distance requiring at least a certain effort of the player to reach it (here minimally 3 km from home location).

As can be taken from these examples there are basically two independent conditions the real-world locations should meet: First the absolute distance from a reference point which will usually be the starting point “home location”. As the home location is considered as a kind of “home base” for a player, absolute distances will usually be measured with respect to this home location, in order to create the required “feeling” of distance corresponding to the game.

There is also the second parameter that is the relative distance between locations which are interrelated, in the case depicted in FIG. 2 for example “cemetery”, which apparently should be located close to the “church”, and the “crypt” which should be located adjacent the “cemetery”. That means, the absolute position with respect to the starting point/home location is not of primary interest, however the relative distance to a related location is. As an example two locations may be required to be located about three kilometers from the player's home each, however it is additionally required for them to be separated by at least four kilometers. The examples here are only intended to be illustrative; there are a lot of similar possibilities for such relations between certain in-game locations. For example, when thinking about a multiplayer game, it may be required that certain locations are agreed on by all participants, or that the required distances are set in relation to locations that another player has defined (for example when the game requires a kind of “meeting place” for all players).

Another possibility that is enabled by the inventive method could be called “mobile re-mapping”, that is, if a player travels/moves to a completely different location he may still continue a game started in his old environment, by re-mapping the in-game locations to new locations in his new environment. This case is related to for example going on vacation or moving to another state due to a new job or the like. The re-mapping can be performed almost identical to the above description and further explanations are thus omitted here.

There are basically three ways a selection of a real-world location can be performed. An easy to implement method requires the player to visit the location he wants to indicate, and then to confirm that his actual location is used. This can be done very easily and is very fool-proof. While this on the one hand requires the gamer to travel to the location first it can on the other hand make the gaming experience more intense.

Another possibility is to let the gamer indicate a location by providing appropriate coordinates, on a map, through GPS coordinates or like. While this does not require visiting the location in the first place it requires additional effort in selection/inputting the coordinates. It is also mandatory for the gamer to have access to a suitable map or like. Irrespective of this aspect this is still a straight forward way of indicating a location.

A third way of providing the needed location information is to have the game (e.g. game server) select a number of appropriate locations and suggest them to a gamer. The game player would then be queried to choose between the proposed alternatives according to his needs. While this may appear to restrict the gaming experience a great deal it offers an additional application. A prerequisite for this alternative to work is of course that the game/game server has access to a suitable map in order to suggest locations. However this enables a very advanced possibility, that is, to choose a number of locations for the gamer according to the in-game location to be mapped thereto. As an example, if an in-game location like “the pub” or “the church” is to be mapped a number of taverns, pubs or the like and churches, chapels etc., respectively, can be pre-selected and proposed to the user. Or to put it another way, a number of locations can be suggested in a context-sensitive manner. Another example might be an in-game location called “caves”, which could be mapped to something like sewers, cellars or like.

This suggestion feature can of course be used in conjunction with other features as well. As mentioned above in multiplayer games it may be required that the players agree upon certain locations. The pre-selection/suggestion feature can be used here easily and conveniently. It should be clear that it is also possible to let the user choose himself in which manner he wishes to indicate the respective real-world location himself, that is, simply going there, providing the coordinates or being offered suggestions.

Depending on the game storyline the suggestion feature might also be combined with a kind of randomization. That is, in order not to spoil the actual location yet, the player could be offered a choice like “pick six locations out of the ones suggested”, such that the player would still have to perform certain actions/solve some objectives in order to find out which of the six locations is the right one to visit. However in this case it might be necessary to prevent the player from “trial and error”, that is, simply visiting all locations until finding the right one. This can easily be solved e.g. by requiring the player to enter some code word when visiting the “right” location, and to let him find out the code word through some objectives/puzzles or the like.

The actual location would then be selected from the accepted six ones within the game, and the player can still enjoy finding out the right one, while he on the other hand can be sure that only “reasonable” locations will be selected by the game (e.g. within his part of the town). In multiplayer games this can also be used to make suggestions for locations that have to be agreed upon by some/all players.

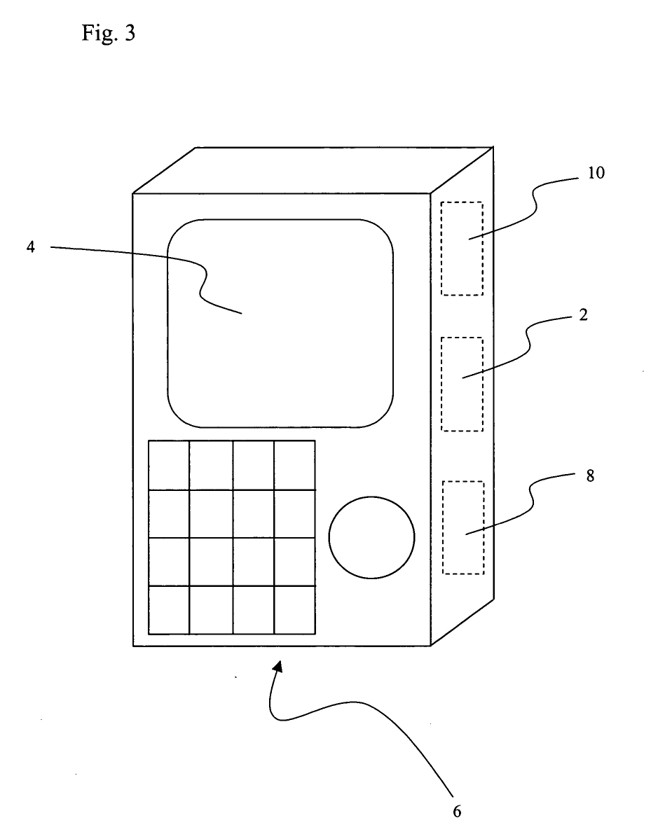

FIG. 3 shows the device according to an embodiment of the present invention. The device comprises a controller 2, a display component 4, an input component 6, a storage component 8 and a location determination component 10 (which is optional). The controller 2 interconnects and controls these components. The display component 4 can be controlled to display a request for a real-world location. A user can enter such an indication via the input component 6. Associations between real-world locations and in-game locations are created by the controller 2 and can be stored in the storage component 8.

The location determination component 10 can be used to determine the actual location of a player using the device, in order to perform advanced implementations of the inventive method as described above. This component 10 can be an “active” component that is adapted to use a suitable method to determine the location, like GPS, cell-based location determination (distance to base stations in a wireless network or like), triangulation and the like. However the component 10 can also be a kind of “passive” location determination component, that is, an interface that is used to receive or obtain the actual location from another entity, a location service server of a wireless network the device operates in, an external GPS receiver coupled via Bluetooth or cable, or other suitable entities.

The invention solves all of the above mentioned problems or prior art location mapping, both 1:1 mapping method and scaling methods A and B. The method here could be called a suggestion mapping method. The game system suggests a game location mapping to the player each time when the player has advanced in the story line to a stage where a new location is introduced into the location based game. This method does not spoil the game location discovery need like scaling method A does. And it can be used to play location based games everywhere—as the unwritten rule of mobile games states—which is a problem with the 1:1 method. The problems of scale mapping method B are also solved, because the player can select the places himself, so he will not end up with any places that might be or become inaccessible for the player. The suggestion method is a most advantageous way to create location based games which can be played everywhere at any time.

What is claimed is:

1. A method for mapping in-game locations of a location based game to real-world locations, comprising the steps of:
determining that a player of said location based game has reached a game stage which requires mapping an in-game location to a real-world location;
obtaining an indication of a real-world location;
verifying said obtained real-world location;
creating an association between said in-game location and said verified real-world location; and
storing said association.

2. The method according to claim 1, wherein said obtaining step is preceded by
requesting an indication of a real-world location.

3. The method according to claim 2, further comprising:
returning to said requesting step in case said obtained real-world location is not verified.

4. The method according to claim 1, wherein a reference real-world location and a minimal and/or maximal distance are defined, and wherein said verifying step comprises
determining the distance of said obtained real-world location to said reference real-world location;
wherein said obtained real-world location is verified if said distance is above said minimal and/or below said maximal distance.

5. The method according to claim 1, wherein said verifying step comprises
retrieving information about said obtained real-world location; and
using said retrieved information to determine if said obtained real-world location is located in an area that is forbidden, unreachable or hazardous to said player;
wherein said obtained real-world location is verified if said obtained real-world location is not located in a forbidden, unreachable or hazardous area.

6. The method according to claim 2, wherein said requesting step comprises
requesting a confirmation that the present location of said player will be used as obtained real-world location;
and wherein said obtaining step comprises
determining the present location of said player responsive to a confirmation; and
using said present location as said obtained real-world location.

7. The method according to claim 2, wherein said requesting step comprises
choosing at least one real-world location and suggesting said chosen real-world location to said player; and
requesting a confirmation that said chosen real-world location will be used as said obtained real-world location;
and wherein said obtaining step comprises
using said chosen real-world location as said obtained real-world location.

8. The method according to claim 7, wherein said at least one real-world location is chosen according to said in-game location.

9. A computer program product comprising program code means stored on a computer readable medium for carrying out the method of claim 1 when said program product is run on a computer or network device.

10. A computer program product comprising program code, downloadable from a server for carrying out the method of claim 1 when said program product is run on a computer or network device.

11. A computer data signal embodied in a carrier wave and representing a program that instructs a computer to perform the steps of the method of claim 1.

12. A device for mapping in-game locations of a location based game to real-world locations, comprising:
a display component;
an input component;
a storage component; and
a controller connected with said display component, said input component and said storage component;
wherein said controller is adapted for
determining that a player of said location based game has reached a game stage which requires mapping an in-game location to a real-world location;
requesting an indication of a real-world location using said display component;
obtaining an indication of a real-world location using said input component;
verifying said obtained real-world location;
creating an association between said in-game location and said verified real-world location; and
storing said association in said storage component.

13. The device according to claim 12, wherein a reference real-world location and a minimal and/or maximal distance are stored in said storage component, and wherein said controller is further adapted for
determining the distance of said obtained real-world location to said reference real-world location;
wherein said controller is adapted to verify said obtained real-world location if said distance is above said minimal and/or below said maximal distance.

14. The device according to claim 12, wherein said controller is further adapted for
retrieving information about said obtained real-world location; and
using said retrieved information to determine if said obtained real-world location is located in an area that is forbidden, unreachable or hazardous to said player;
wherein said controller verifies said obtained real-world location if said obtained real-world location is not located in a forbidden, unreachable or hazardous area.

15. The device according to claim 12, further comprising
a location determination component;
and wherein said controller is further adapted for
requesting a confirmation that the present location of said player will be used as the real-world location using said display component;
determining the present location of said player using said location determination component, responsive to a confirmation through said input component; and
using said present location as said obtained real-world location.

16. The device according to claim 12, wherein a number of real-world locations are stored in said storage component, and wherein said controller is further adapted for
choosing at least one of said stored real-world locations and suggesting said chosen real-world location to said player using said display component;
requesting a confirmation that said chosen real-world location will be used as said obtained real-world location using said display component; and
using said chosen real-world location as said obtained real-world location responsive to a confirmation through said input component.

17. The device according to claim 16, wherein said controller is further adapted for
choosing said at least one real-world location according to said in-game location.

18. The device according to claim 12, wherein said device is a mobile gaming terminal.
